(19) United States
(12) Patent Application Publication
(10) Pub. No.: US 2011/0255677 A1
(43) Pub. Date: Oct. 20, 2011

(54) Enhanced location based call related information (Caller ID)

(76) Inventor: Farhad Kasad, Bothell, WA (US)

(21) Appl. No.: 13/064,756

(22) Filed: Apr. 13, 2011

Related U.S. Application Data
(60) Provisional application No. 61/282,887, filed on Apr. 16, 2010.

(51) Int. Cl. H04M 1/56

(52) U.S. Cl. 379/142.1

(57) ABSTRACT

The current location of a calling device is provided to a called device only to a level authorized by the calling party and/or their servicing network. A configuration file may be maintained in, e.g., a current location privacy settings database. The current location of the calling device is provided to the called device only to the extent authorized, e.g., coarse (e.g., blurred), or precise (e.g., with full detail). The current location of the calling device may be blurred if desired, and is returned to the called device as Enhanced Location based call related information (e.g., Caller ID). The provision of a caller's current location may be tied to an add-on service by the wireless network provider. With such a service activated, the called subscriber with the service will receive otherwise conventional CallerID information together with the inventive current location of the caller.

This application claims priority from U.S. Provisional Application No. 61/282,887 entitled “Enhanced Location Based Call Related Information (Caller ID)” filed Apr. 16, 2010, the entirety of which is expressly incorporated herein by reference.

### BACKGROUND OF THE INVENTION

1. Field of the Invention

This invention relates generally to telecommunications, Voice Over Internet Protocol (VoIP), cellular communications, and location based systems.

2. Background of Related Art

Call related information such as Caller ID (CID), also called Calling number identification (CNID), is a service available in phones and VoIP applications that transmits a caller's number to a called party's phone equipment, during the time when the call is set up, but before the call is answered. In legacy landline embodiments, call related information is provided to the called party between the first and second ring signals.

Location for an incoming call is not automatically provided to a called party. Location for an incoming call can at best only be approximated from CallerID using the first three digits of the incoming phone number (i.e., the area code).

### SUMMARY OF THE INVENTION

In accordance with the principles of the present invention, a method of receiving call related location information of a caller at a called device comprises receiving a call request from a calling device to a called device. Before said called device accepts the call request, a current location of the calling device is received. As the called device alerts to an incoming call, the current location of the calling device is displayed at the called device.

In accordance with another aspect of the invention, a method of providing call related location services to a called party comprises receiving a call request from a calling party. A location request is transmitted to a location based services (LBS) server. A response to the location request containing a current location of the calling party is received. The current location is provided to a party called by the calling party.

In accordance with yet another aspect, a method of receiving call related location of a calling party by a called party comprises receiving a call request from a calling party. Before the call request is answered by the called party, a GPS-obtained current location of the calling party is received from the calling party. The GPS-obtained current location of the calling party is displayed on the called device.

### BRIEF DESCRIPTION OF THE DRAWINGS

Features and advantages of the present invention will become apparent to those skilled in the art from the following description with reference to the drawings, in which:

FIG. 1 shows an exemplary embodiment of a communications network including call related location information services providing a current location of a caller at a time of initiating a phone call to a called party, to the called party, in accordance with the principles of the present invention.

FIG. 2 shows another exemplary embodiment of a communications network including call related location information services providing a current location of a caller at a time of initiating a phone call to a called party, to the called party, including a database of privacy settings relating to a subscriber placing the call, in accordance with the principles of the present invention.

FIG. 3 shows yet another exemplary embodiment of a communications network including call related location information services providing a current location of a caller at a time of initiating a phone call to a called party, to the called party, including a database maintaining information relating to called parties who have enrolled in a subscriber call related location subscription service, in accordance with the principles of the present invention.

FIG. 4 shows a first exemplary procedure for obtaining a current location of a caller from a network location based services (LBS) server, and providing the same to the called party before acceptance of the incoming call, in accordance with the principles of the present invention.

FIG. 5 shows a first exemplary procedure for providing a current location of a caller from a calling device itself, and providing the same to the called party before acceptance of the incoming call, in accordance with the principles of the present invention.

### DETAILED DESCRIPTION OF ILLUSTRATIVE EMBODIMENTS

Current technologies do not indicate a precise (or even a coarse) location specifying where a caller is actually calling from. This is particularly true in the wireless world where a person typically has a mobile phone number that carries an area code commonly associated with one place (e.g., their home), yet as they roam they may call from literally anywhere in the country.

The present invention provides methods and technologies that supply the current location of a caller to a called party before the called party answers the call using location based system (LBS) technologies. The caller's current location is provided along with information otherwise provided as call-related information (e.g., the conventional caller ID). The caller's current location is preferably provided to landline and mobile phones, including Voice Over Internet Protocol (VoIP) phones.

In preferred embodiments, the current location of a calling party is provided to the called party in an out-of-band communication channel, i.e., separate from the voice channel. In a wireless network the current location may be provided in a packet data communications channel between the wireless device and the serving wireless network.

In accordance with the principles of the present invention, the caller's current location, referred to herein as call related location, may be provided to the called party along with otherwise conventional call related information such as the phone number of the caller.

In some embodiments, the caller's name, phone number, and caller's current location are all provided to the called party as part of the call setup procedure. In other embodiments, particularly where display space is limited on the called party's receiving device, limited call related information may be displayed. For instance, only the caller's current location may be displayed with the caller's name; or only the caller's current location may be displayed with the caller's phone number.

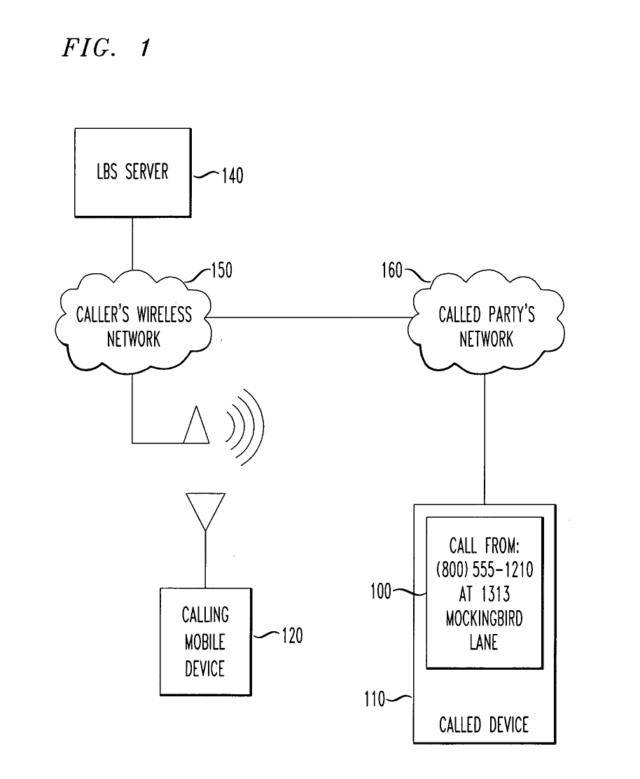

FIG. 1 shows an exemplary embodiment of a communications network including call related location information services providing a current location of a caller at a time of initiating a phone call to a called party, to the called party, in accordance with the principles of the present invention.

In particular, as shown in FIG. 1, a calling mobile device 120 places a call to a called device 110 which includes a display 100 to display call related information including a location of a calling party. The called party calls via their servicing wireless network 150, and may make use of the same or a different called party's network 160.

When a call is placed by the calling mobile device 120, a location request is triggered in the caller's wireless network 150 to a location based services (LBS) server 140, which obtains and routes a current location of the caller to the called device 110.

Alternatively, if the calling mobile device 120 has the capability to provide its own location, the current location of the caller's calling device 120 may be provided to the caller's wireless network 150 for provision to the called device 110 during the call setup procedures.

When using a location obtained by the calling device 110 itself, a latitude/longitude (lat/lon) type measurement may be provided. In such case, the called device 110 may display the raw lat/lon location of the caller on its call related information display 100, or may first implement a lookup to a Geographical Information System (GIS) or similar server to determine a more user-friendly version of the current location of the caller, e.g., a street address closest to where the caller using the calling mobile device 120 is currently calling from.

In another embodiment, a lookup of the lat/lon information to a valid street address may be performed by a suitable network server, and the valid street address information may be provided to the called device 110, though lookup for a valid street address before providing the call related location to the called device 110 may cause undesirable delay in some networks of passage of the calling device's 120 current location information to the called device 110.

Depending upon the capabilities of the called device 110, the call related information provided to the called device may indicate the geographic current location of the calling device 120 in an appropriate manner, for example, along with an Arial Map, satellite map, road map, or similar.

In an alternative embodiment, if the calling device 120 has self-locating capabilities (such as global positioning system (GPS)), the calling device's 120 current location may be provided by the calling device 120 itself to the caller's wireless network 150 for use in the call setup and provision of call related information to the called device 110.

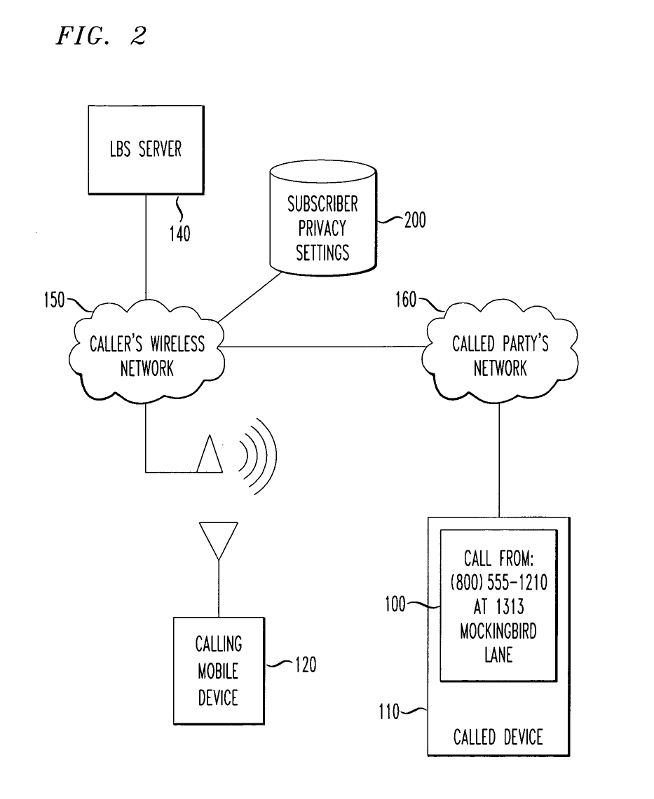

FIG. 2 shows another exemplary embodiment of a communications network including call related location information services providing a current location of a caller at a time of initiating a phone call to a called party, to the called party, including a database of privacy settings 200 relating to a subscriber placing the call, in accordance with the principles of the present invention.

In particular, as shown in FIG. 2, a database of subscriber privacy settings 200 is accessible by the caller's wireless network 150. Though shown in communication with the caller's wireless network 150, the database of subscriber privacy settings 200 may instead, or additionally, be in communication with the called party's network 160.

Entries in the subscriber privacy settings database 200 are preferably pre-configured, e.g., during initial registration of the calling mobile device 120 in the relevant network. Each entry in the subscriber privacy settings database 200 preferably contains information sufficient to uniquely identify a given calling mobile device 120 and/or a given user.

In operation, once an accurate current location of the caller is obtained, e.g., via request to the LBS server 140, an accuracy of the caller's current location may be ‘blurred’ from its full accuracy to a suitably inaccurate location, based on a level of privacy for providing location pre-established by the caller on the calling mobile device 120. The blurring of the current location information of the calling mobile device 120 avoids the situation where the calling mobile device 120 does not intend to give accurate information to the called party sufficient to pin point the current location of the caller.

Blurring of the current location of the calling mobile device 120 may be blurred (additionally or alternatively) in accordance with a minimum privacy setting pre-established by network privacy requirements.

In a blurred or reduced accuracy condition, the call related information provided to the called device 110 may simply be a generalized (but accurate) current location of the calling device 120, appropriately informing the called party before they accept the incoming call. For instance, the current location of the calling device 120 may be provided as only the city in which the caller is calling from. In a more accurate form, the current location of the caller may be provided as a full street address.

Though described as being pre-established, privacy settings may be established on a call-by-call basis on the calling mobile device 120. For instance, when placing a call, a caller may select a given privacy level for that particular call from a set of choices for the provision of location, before activating a ‘SEND’ button. Alternatively, the level of privacy may be pre-established on the calling mobile device 120 (or in the caller's wireless network 150 and associated with the calling mobile device 120) in a contact list which presumably includes the called device 110. In such case, if the called device 110 is not included in the contact list the level of privacy may take a default, pre-configured value.

As an example of blurred accuracy of a current location, the current location of a calling device 120 may be provided only as a postal ZIP code, or city name.

A suitable subscriber privacy settings database may be provided via, e.g., the commercially-available Xypoint Location Services Gateway (XLSG) product commercially available from TeleCommunication Systems, Inc. of Annapolis, Md., US. The XLSG is a combination of a privacy hub with a steering gateway. The location services gateway XLSG manages privacy at an LCS client and subscriber level. The subscriber is provisioned in the XLSG with privacy settings. The XLSG also manages steering rules. Thus, depending upon the type of request, device, and/or network, a call can be routed to either GMLC/MPC, SMLC or SUPL.

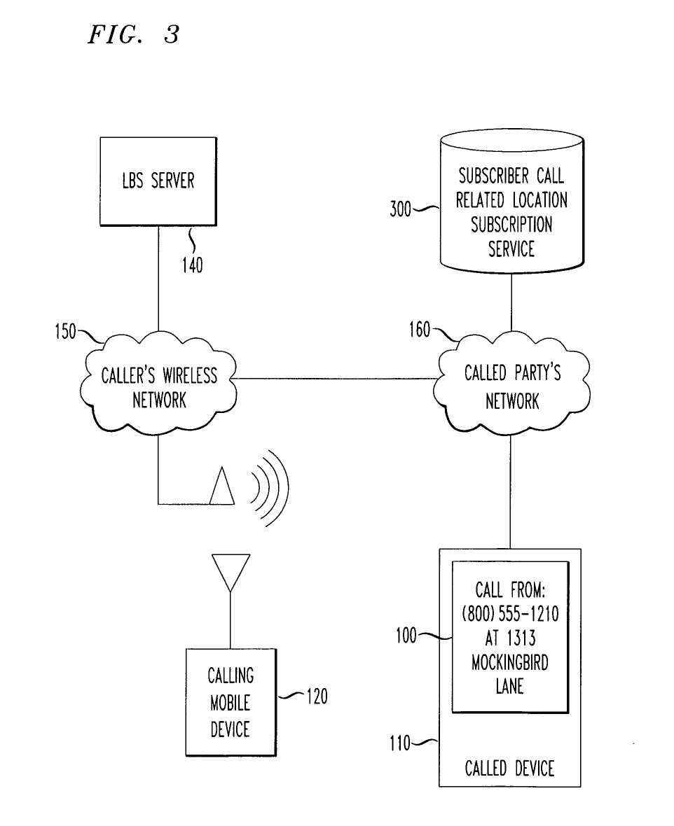

FIG. 3 shows yet another exemplary embodiment of a communications network including call related location information services providing a current location of a caller at a time of initiating a phone call to a called party, to the called party, including a database maintaining information relating to called parties who have enrolled in a subscriber call related location subscription service, in accordance with the principles of the present invention.

In particular, as shown in FIG. 3, the called party's network 160 may have access to a suitable subscriber call related location subscription service 300, providing the wireless network with an additional means of revenue. Using such service, the called party's network 160 will verify subscription of the called device 110 to the current location service, before provision of the current location information.

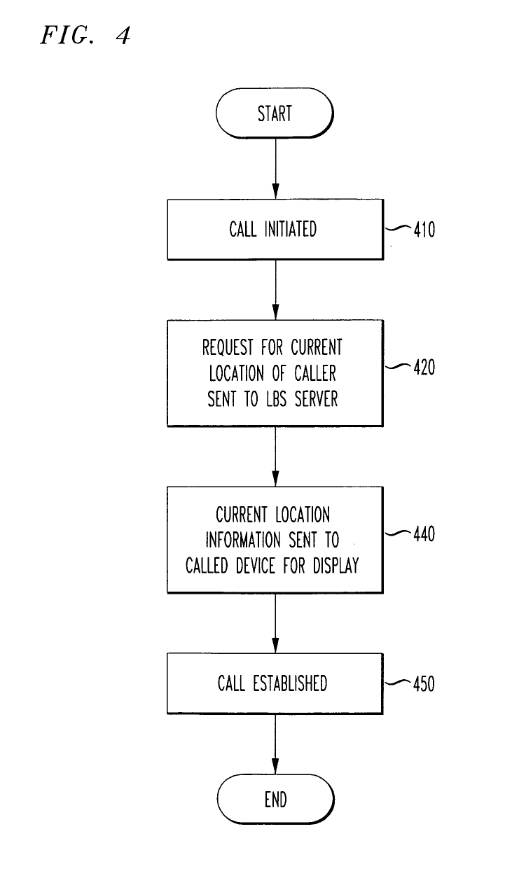

FIG. 4 shows a first exemplary procedure for obtaining a current location of a caller from a network location based services (LBS) server, and providing the same to the called party before acceptance of the incoming call, in accordance with the principles of the present invention.

An exemplary call flow is similar to that for cellular 911 (emergency) call flow, which makes every phone landline, cell phone or VoIP a potential location device, though each involves a variation in the call flow and specific technologies used.

In operation, when a call is placed, a location request is triggered by the caller's call. A location request is sent to an appropriate location server 140 using location based services (LBS) technologies, requesting a current location of a calling device 120, subject to any privacy configuration settings established by the caller.

In particular, as shown in step 410 of FIG. 4, a call is initiated from a calling device 120 to a called device 110.

In step 420, a request for current location of the calling device 120 is sent to the LBS server 140. In accordance with the present invention, during call setup, a location request is made using coarse or precise location technologies (e.g., MPC, GMLC, SMLC, SUPL). The request may be initiated from within the caller's wireless network 150, with the responsive current location of the calling device 120 being routed to the called device 110. Alternatively, the called party's network 160 may request the current location of the calling device 120 as a service to the called device 110.

Thus, when a call is placed, an MLP request is sent to the location based services (LBS) server 140. The call related information (e.g., Caller ID (CID)) validation occurs at the same time.

In step 440, current location information relating to the calling device 120 is sent to the called device 110 for display on its display 100.

Preferably the location server 140 is configured to send the best possible position first, and may continue to acquire a precise location of the calling device 120 for provision as call related information if a relevant feature is enabled, subscribed to, paid for, or otherwise provisioned. (XLSG profile) by the called device 110.

In step 450, upon review of current location information of the calling device 120, the called device 110 answers the call.

In other embodiments, the current location of the calling device 120 may be provided to the called device 110 after establishment of the call. This is particularly useful in emergency systems and emergency scenarios.

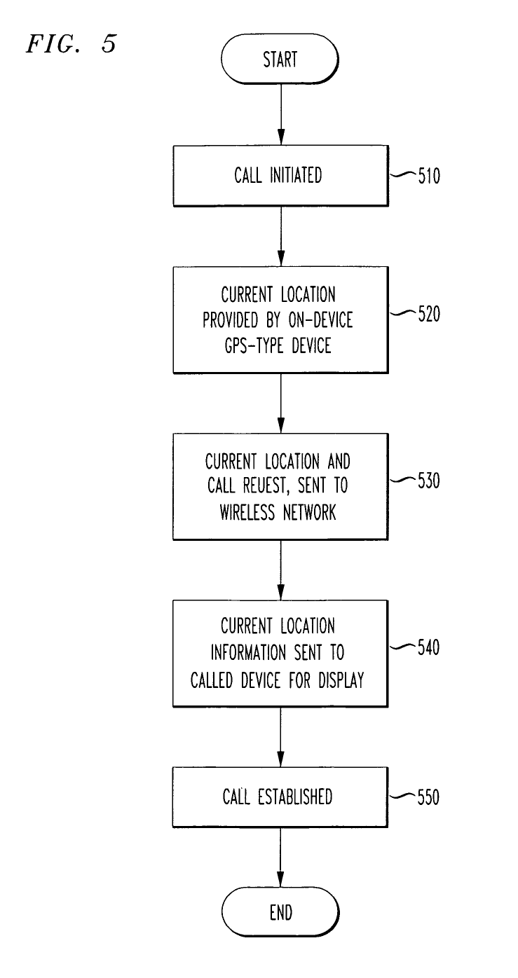

FIG. 5 shows a first exemplary procedure for providing a current location of a caller from a calling device itself, and providing the same to the called party before acceptance of the incoming call, in accordance with the principles of the present invention.

In particular, as shown in step 510 of FIG. 5, a call is initiated.

In step 520, the current location of the calling device 120 is provided by an on-device satellite location system such as GPS located on the calling device 120 itself.

In step 530, the current location of the calling device 120, and call request for the call itself, is transmitted by the calling device 120 to the caller's wireless network 150.

In step 540, current location information is sent to the called device 110 for display.

In step 550, the call is established between the calling device 120 and the called device 110, with the current location of the calling device 120 being obtained from the calling device 120 itself.

In accordance with the principles of the present invention, the current location of a calling device 120 is provided to a called device 110 only to a level authorized by the calling party and/or their servicing network 150. Thus, in accordance with a configuration file maintained in, e.g., a current location privacy settings database 200, the current location of the calling device 120 is provided to the called device 110 only to the extent authorized, e.g., coarse (e.g., blurred), or precise (e.g., with full detail). The current location of the calling device 120 may be blurred if desired, and is returned to the called device 110 as Enhanced Location based call related information (e.g., Caller ID).

The provision of a caller's current location may be tied to an add-on service by the wireless network provider. Hence, with such a service activated, the called subscriber with the service will receive otherwise conventional CallerID information together with the inventive current location of the caller.

In another embodiment, a reverse call related information service may be provided. In such an embodiment, a calling device may obtain the current location of a called device, subject to any privacy settings applicable to the called device (e.g., a phone-based enablement of location services). Such a service has particular applicability for emergency personal, e.g., in the case of a dropped emergency call, or no voice situation.

This LBS infrastructure is geared to be used by a hand held application. A different architecture may be preferred to which a light weight XLSG plus PDE/PDM may be used.

In accordance with the invention, call related location information may be used by called parties in a useful manner, e.g., to track down or limit the impact of telemarketers, prank calls and other intrusions. In another application, the use of enhanced-location based call related information (Caller ID) in accordance with the principles of the present invention provides the ability for a called party to provide a greater level of assistance (e.g., enabling them to make a call to a neighbor, nearby gas station, etc.) in the event of a non-emergency call by the caller.

This invention has particular applicability to cellular communications, landline communications, Voice Over Internet Protocol (VoIP) communications, and smart phones and other handheld devices.

While the invention has been described with reference to the exemplary embodiments thereof, those skilled in the art will be able to make various modifications to the described embodiments of the invention without departing from the true spirit and scope of the invention.

What is claimed is:

1. A method of receiving call related location information of a caller at a called device, comprising:
receiving a call request from a calling device to a called device;
before accepting said call request at said called device, receiving a current location of said calling device; and
displaying, as said called device alerts to an incoming call, said current location of said calling device at said called device.

2. The method of receiving call related location information of a caller at a called device according to claim 1, further comprising:
requesting a current location of said calling device from a location based services (LBS) server.

3. The method of receiving call related location information of a caller at a called device according to claim 1, wherein:
said current location is received by said called device as a street address of said calling party.

4. The method of receiving call related location information of a caller at a called device according to claim 1, wherein:
said current location is received by said called device as a latitude/longitude of said calling party.

5. A method of providing call related location services to a called party, comprising:
receiving a call request from a calling party;
transmitting a location request to a location based services (LBS) server;
receiving a response to said location request containing a current location of said calling party; and
providing said current location to a party called by said calling party.

6. The method of providing call related location services to a called party according to claim 5, further comprising:
authorizing said called device for receipt of said current location of said calling party.

7. A method of receiving call related location of a calling party by a called party, comprising:
receiving a call request from a calling party;
before said call request is answered by said called party, receiving a GPS-obtained current location of said calling party, from said calling party; and
displaying said GPS-obtained current location of said calling party on said called device.

8. The method of receiving call related location of a calling party by a called party according to claim 7, further comprising:
obtaining authorization for said called device to receive said GPS-obtained current location.

9. The method of receiving call related location of a calling party by a called party according to claim 7, wherein:
said GPS-obtained current location of said calling party is a street address.

10. The method of receiving call related location of a calling party by a called party according to claim 7, wherein:
said GPS-obtained current location of said calling party is a latitude/longitude.
